(19) United States
(12) Patent Application Publication
(10) Pub. No.: US 2019/0101459 A1
(43) Pub. Date: Apr. 4, 2019

(54) APPARATUS FOR AND METHODS OF ACOUSTIC THERMOMETRY

(71) Applicant: The Regents of the University of California, Oakland, CA (US)

(72) Inventor: Maxim Martchevskii, Clayton, CA (US)

(21) Appl. No.: 16/207,482

(22) Filed: Dec. 3, 2018

Related U.S. Application Data
(63) Continuation of application No. PCT/US2017/036051, filed on Jun. 6, 2017.
(60) Provisional application No. 62/348,523, filed on Jun. 10, 2016.

(51) Int. Cl. G01K 11/26; G01N 29/44; G01N 29/24; G01N 29/12

(52) U.S. Cl. CPC G01K 11/26; G01N 29/12; G01N 29/2418; G01N 29/4427

(57) ABSTRACT

This disclosure provides systems, methods, and apparatus related to thermometry. In one aspect, a method includes applying a first mechanical pulse to an object. The first vibrational response of the object to the first mechanical pulse is recorded. A second mechanical pulse is applied to the object. A second vibrational response of the object to the second mechanical pulse. The second vibrational response is compared to the first vibrational response to determine a change in a temperature in the object.

### RELATED APPLICATIONS

This application is a continuation of International Application No. PCT/US17/36051, filed Jun. 6, 2017, which claims priority to U.S. Provisional Patent Application Ser. No. 62/348,523, filed Jun. 10, 2016, both of which are herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to thermometry and more particularly to acoustic thermometry.

### BACKGROUND

A robust and reliable detection of spontaneous quenching is essential for protecting superconducting magnets and machinery from thermal damage. For coils made of high-temperature superconductors (HTS), sensitivity of the conventional quench detection approach based on measuring resistive voltages may be insufficient to detect hot spots early enough, especially in large systems exhibiting a high level of electromagnetic noise. This is because quench propagation velocity in HTS conductors is 2 to 3 orders of magnitude lower than in conventional superconductors, and a normal zone may heat up significantly before any resistive voltage across it becomes measurable.

### SUMMARY

Described herein are apparatus and methods for detecting and monitoring temperature changes of a solid body by monitoring the natural resonances (i.e., the eigenfrequencies) of the solid body. Natural resonances of any mechanical system correspond to its various vibrational degrees of freedom (e.g., compression, twist, tilt, etc.) that are uniquely defined by the geometry, mass, and stiffness (i.e., Young's modulus, also referred to as the elastic modulus) of the system. The Young's modulus is weakly dependent on temperature about 10 parts per million (ppm) of relative change in Young's modulus per degree Kelvin (K) for most metallic objects. The associated natural frequency shift is about ½ of the Young's modulus relative change, which is about 1 ppm/K to 10 ppm/K. Such frequency shifts are generally too small to enable frequency-based temperature monitoring.

If the most prominent eigenmodes, however, are in the MHz range, which is the case for very small and/or thin objects, the frequency shifts may be used to enable frequency-based temperature monitoring. The method described herein relies upon a high (e.g., about 100 to 500) mechanical quality factor of typical solids, allowing the small temperature-related phase shift to accumulate over many (e.g., about 200 to 1000) oscillation periods following the initial pulsed excitation. This approach improves measurement sensitivity by the same factor (i.e., about 200 to 1000), thus making temperature-related Young's modulus variations of the order of 0.1 ppm to 1 ppm readily detectable.

One innovative aspect of the subject matter described in this disclosure can be implemented in a method including (a) applying a first mechanical pulse to an object; (b) recording a first vibrational response of the object to the first mechanical pulse; (c) applying a second mechanical pulse to the object; (d) recording a second vibrational response of the object to the second mechanical pulse; and (e) comparing the second vibrational response to the first vibrational response to determine a change in a temperature in the object.

In some implementations, operation (e) includes determining a time difference in the first vibrational response and the second vibrational response. In some implementations, operation (e) includes extracting about 5 oscillation periods to 20 oscillations periods of a first waveform of the first vibrational response of the object; determining a first time, wherein the first time is a period of time between the application of the first mechanical pulse to the object and the about 5 oscillation periods to 20 oscillations periods of the first waveform; extracting about 5 oscillation periods to 20 oscillations periods of a second waveform of the second vibrational response of the object; determining a second time, wherein the second time is a period of time between the application of the second mechanical pulse to the object and the about 5 oscillation periods to 20 oscillations periods of the second waveform; and determining a time difference between the first time and the second time, wherein the time difference is proportional to a change in the temperature in the object.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a flow diagram illustrating a process for determining a temperature change in an object.

FIGS. 2A-2C show examples of schematic illustrations of apparatus for determining a temperature change of an object.

FIG. 3A shows the voltage waveform at the receiving transducer calculated for the reference (unmodified) stack assembly. Two sub-waveforms of duration t_{w}=5 μs were selected (marked in the graph) for comparison to those of the modified stack. FIG. 3B shows the sub-waveforms starting at 45 μs into the transient (showing their good mutual registry). FIG. 3C shows the sub-waveforms starting at 595 μs into the transient (show an accumulated systematic time shift). FIG. 3D shows the time shift τ(τ) between the transient sub-waveforms of the reference and modified stack assembly.

FIG. 4A shows a transient waveform acquired by the receiving transducer. The time window of the excitation pulse is shown in the graph with the line at the left hand side. A prevailing ringdown frequency component of the transient is centered at ˜200 kHz. FIG. 4B shows the voltage across the HTS conductor measured during a linear current ramp. FIG. 4C shows the time shift τ for the transient sub-waveform acquired during the same current ramp. FIG. 4D shows the time shift τ and voltage across the conductor plotted versus the applied current.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a value is close to a targeted value, where close can mean, for example, the value is within 80% of the targeted value, within 90% of the targeted value, within 95% of the targeted value, or within 99% of the targeted value.

Acoustic thermometry can be applied to liquids and gaseous bodies. It relies upon measuring a thermally induced change of the sound velocity c(T). Such measurement can be accomplished by generating an acoustic pulse, and measuring its travel time across the body. Piezoelectric transducers can be used for transmitting and receiving such pulses, having either two transducers—a transmitter and a receiver placed at the opposite sides of the body, or a single transducer in a pulse-echo operating mode. However, this simple approach is not very practical for application to solids.

For example, in a quasi-one-dimensional solid rod, the transverse sound velocity is v=√E/ρ, and its temperature dependence is dominated by that of the Young's modulus E(T) rather than a much smaller density variation ρ(T). The former can be approximated as

$$E ( T ) = {E}_{0} - s / [ {e}^{\frac{t}{T}} - 1 ] \qquad ( 1 )$$

where E₀ is the zero-temperature value, and s and t are adjustable parameters. For common metals and alloys at liquid nitrogen temperature (77 K), the relative change 1−E(T+ΔT)/E(T) is then just ˜1×10⁻⁴ K⁻¹, yielding an about 2 to 3 orders of magnitude smaller sound velocity change per degree than in liquids or gases.

Another significant complication is that a large variety of wave modes exist in solids, including compression, shear, twist, and Lamb surface waves. Those wave modes exhibit different group velocities and can evolve from one mode to another along the body surfaces and interfaces. Once a solid body is excited with a pulsed mechanical excitation at to, it would “ring down,” yielding multiple transient oscillations and wave mode conversions before the initial pulse energy is fully dissipated into heat. A superposition of eigenmodes corresponding to the body's structural degrees of freedom will dominate its transient response once waves have bounced repeatedly from external boundaries and internal interfaces. The resulting spatio-temporal distribution of the deformation is then uniquely defined by the density and Young's modulus distribution in the body while the time decay of the transient response is proportional to the rate of mechanical energy loss. Transients can be excited and monitored for changes repeatedly, provided that the interval between the excitation pulses is longer than the transient decay time. Should a sudden structural change, such as cracking or delamination inside an epoxy-impregnated coil occur, for example, the transient waveform shape will change drastically. This phenomenon constitutes the basis for various non-destructive evaluation techniques.

A much more subtle yet continuous thermally induced variation of the transient is expected due to a temperature dependence of elastic constants, since eigenfrequencies follow the same square-root functional dependence upon Young's modulus as does the sound velocity. One can therefore expect a similar 10⁻⁴ to 10⁻⁵ K⁻¹ magnitude of thermal frequency shift of the mechanical modes comprising the transient. To detect a shift this small, one can rely upon the body's fairly large mechanical Q-factor (defined as a number of transient oscillation periods over which their amplitude decreases by a factor of e^{-π}), typically ranging from about 10² at ambient conditions to about 10³ at cryogenic temperatures for most metallic structures. For single-mode resonators, such as electromechanical quartz resonators, for example (Q about 10⁴ at room temperature and greater than 10⁶ at 4.2 K), thermal frequency shifts can be monitored in either a continuous oscillation or a pulsed transient mode. But for a structurally complex object such as a superconducting magnet coil where a large variety of mechanical modes can be excited simultaneously, monitoring changes in its overall transient response is a more practical approach.

To quantify such changes, an excitation pulse can be applied to the body at t₀ and a fixed portion of the transient waveform of a duration t_{w} starting at t₀+Δt can be acquired. The first acquired waveform f₀(t) is stored as a reference and then cross-correlated with every subsequently-acquired waveform fᵢ(t) to find

Fᵢ(t)=∫ₜ_{₀}_{+Δt}^{t}^{₀}^{+Δt+t}^{_{w}}fᵢ(t−x)f₀(t)dx. (2)

The relative time shift τi is then calculated, corresponding to the absolute maximum of each Fi(t) in the [−0.5tw, 0.5tw] interval, such as that F′i(τi)=0; F″i(τi)<0. Thermal sensitivity is expected to be proportional to Δt, and thus, one can benefit from the large mechanical Q-factor by increasing Δt further into the “tail” of the transient waveform.

The technique is “integrative”, in a sense that the net shift of the acoustic transient is proportional to the net amount of heat ΔQ released in the monitored body, assuming

ΔQ·∫ΔT(x,y,z)dV˜∫ΔE(T(x,y,z))dV. (3)

With respect to temperature, this means that both magnitude of the temperature variation, and volume fraction in which such variation occurs will affect the magnitude of the shift. Nevertheless, due to a high sensitivity of the technique, detecting “local” hot spots occupying even a tiny fraction of the overall volume is possible.

The method described herein can be used for detecting quenches in HTS conductor stacks (such as coil windings, cables, etc.) based on monitoring their internal temperature with acoustic waves. The approach is non-invasive, as it relies upon instrumentation placed outside of the stack interior. It is largely insensitive to electromagnetic and mechanical noise in the system, in contrast to the passive acoustic quench detection techniques aimed at analyzing sound emission from the quench zone. The method also differs from the earlier proposed quench detection strategies relying upon measuring local thermally induced stresses, and thus allows to decouple stress and thermal monitoring for the same object.

While portions of this specification are directed to detecting quenches in HTS conductor stacks, the apparatus and methods described herein can be used to detect the temperature or temperature changes in any solid object. For example, systems and applications that could benefit from the apparatus and methods describe herein include temperature monitoring in cryogenic systems, temperature monitoring in chemical and nuclear reactors, monitoring moving parts of various machinery, integrated thermal monitoring in conveyors of manufacturing plants, medical monitoring applications, and thermal monitoring and management for micro- and nano-scaled objects.

Embodiments described herein allow a solid object itself to act as a bulk thermometer, thus permitting sensitive and non-invasive monitoring of temperature for the objects that cannot be instrumented directly with temperature sensors due to environmental, dimensional, or other constraints. Also, since the technique detects temperature changes in the bulk of the object, the measurement error and delayed response associated with conventional solid-state sensor thermometers can be eliminated.

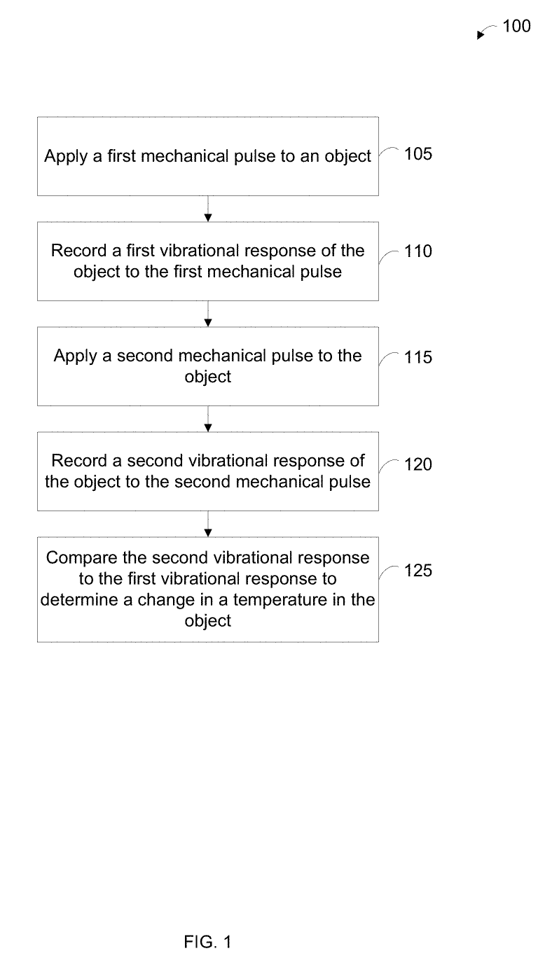

FIG. 1 shows an example of a flow diagram illustrating a process for determining a temperature change in an object. Starting at block 105 of the method 100, a first mechanical pulse is applied to an object. Applying a mechanical pulse to the object imparts a mechanical excitation to the object. By applying a mechanical pulse to the object, a mechanical excitation travels through the object. The mechanical excitation is a sound wave or an acoustic wave that travels through the object. In some embodiments, the object is in a solid state (i.e., a solid object). That is, the object is not a liquid or a gas in some embodiments. In some embodiments, the object is solid to a degree that damping of acoustic signal is not so large that the vibrational response of the object to the first mechanical pulse cannot be detected.

The duration of the first mechanical pulse depends in part on the size of the object and the size of the transducer used to generate the mechanical pulse. In some embodiments, the first mechanical pulse has duration of about 0.1 microseconds (μs) to 50 microseconds or about 0.2 microseconds to 20 microseconds. In some embodiments, the duration of the first mechanical pulse is the same as half the resonance frequency of the transducer. A first mechanical pulse of this duration can produce resonance in the transducer and impart a higher energy first mechanical pulse to the object. In some embodiments, the duration of the first mechanical pulse is not longer than half the resonance period of the transducer.

In some embodiments, a short (i.e., short in duration) first mechanical pulse is desirable. However, the shorter the first mechanical pulse, the less energy in the mechanical pulse. The first mechanical pulse needs to have enough energy to generate a sound wave that travels through the object. For example, an ideal first mechanical pulse would be a delta function. No real pulse, however, can be a true delta-function, as amplitude is limited. Thus, in some embodiments, the first mechanical pulse comprises a rectangular mechanical pulse or a square mechanical pulse. For example, a square mechanical pulse is one period of a non-sinusoidal periodic waveform in which the amplitude alternates at a steady frequency between zero and a fixed maximum value. The period is period in which the waveform alternates from zero to the fixed maximum value and back to zero. Further, the larger the object, the longer the first mechanical pulse can be.

The energy of the first mechanical pulse depends in part on the size of the object. In some embodiments, the first mechanical pulse has an energy of less than about 1 millijoule (mJ). In some embodiments, the duration of the first mechanical pulse is such that a maximal amount of energy or a large amount of energy is imparted to the object.

In some embodiments, the first mechanical pulse is applied to the object with a piezoelectric transducer. In some embodiments, the first mechanical pulse is applied to the object with an electromagnetic acoustic transducer (EMAT, generally comprising a coil and a magnet). In some embodiments, the first mechanical pulse is applied to the object with a laser generating a pulsed laser beam using a photo-acoustic mechanism.

As the sound wave (i.e., the vibrational response) from the first mechanical pulse travels through the object, it reflects off of boundaries and interfaces in the object. At block 110, the first vibrational response of the object to the first mechanical pulse is recorded. The first vibrational response comprises a waveform. The vibrational response of an object normally comprises a sum of sinusoidal harmonics that correspond to the eigenniodes of the object bound within an exponential decay envelope. The waveform detected is determined in part by the reflections off of the boundaries and interfaces in the solid. This waveform is determined by the speed of sound in the object and the geometry of the object.

In some embodiments, the transducer that generates the first mechanical pulse (i.e., the transmitting transducer) and the transducer that detects the first vibrational response (i.e., the receiving transducer) are spaced apart from one another. For example, in some embodiments, a distance between the transmitting transducer and the receiving transducer is at least about 10 centimeters. The maximum distance between the transmitting transducer and the receiving transducer is limited by the size of the object and by the ability of the receiving transducer to detect a vibrational response generated by the transmitting transducer. This also involves the sensitivity of the receiving transducer and signal amplification. For example, if the transmitting transducer and the receiving transducer are spaced a large distance apart from one another and the mechanical pulse generated by the transmitting transducer is weak (i.e., the mechanical pulse is weak), the receiving transducer may not detect the vibrational response. In some embodiments, the same (i.e., a single) transducer is used to generate the first mechanical pulse and to detect the first vibrational response.

In some embodiments, the vibrational response of the object is detected with a piezoelectric transducer. In some embodiments, the vibrational response of the object is detected with an EMAT. In some embodiments, the vibrational response of the object is detected with an optical (e.g., using a laser), capacitive, or magnetic technique. In some embodiments, the vibrational response of the object is recorded with an oscilloscope.

At block 115, a second mechanical pulse is applied to the object. In some embodiments, the second mechanical pulse is applied to the object with the same type of transducer with which the first mechanical pulse is applied to the object. In some embodiments, the second mechanical pulse is applied to the object with the same transducer with which the first mechanical pulse is applied to the object. In some embodiments, the first mechanical pulse and the second mechanical pulse have a same amplitude and a same duration (i.e., the first mechanical pulse is identical or substantially identical to the second mechanical pulse).

In some embodiments, the second mechanical pulse is applied after the vibrational response from the first pulse decreases in amplitude below the detection level. Stated in a different manner, in some embodiments, the second mechanical pulse is applied after the first vibrational response of the object is not able to be detected. For example, for large objects comprising a low damping coefficient material or materials, the first vibrational response will be possible to detect for a long period of time and the second mechanical pulse will be applied at a later time. In some embodiments, the second mechanical pulse is applied about 2 milliseconds to 5 milliseconds after the first mechanical pulse is applied to the object.

At block 120, the second vibrational response of the object to the second mechanical pulse is recorded. In some embodiments, the second vibrational response is detected with same type of transducer with which the first vibrational response is detected. In some embodiments, the second vibrational response is detected with same transducer with which the first vibrational response is detected. In some embodiments, the same a single) transducer is used to generate the second mechanical pulse and to detect the second vibrational response. In some embodiments, the same (i.e., a single) transducer is used to generate the first and the second mechanical pulses and to detect the first and the second vibrational responses.

If there is a temperature change in the object somewhere along the path that the first mechanical pulse and the second mechanical pulse travel in the solid, there is a change in the Young's modulus of the object at this point. A change in the Young's modulus translates to a change in the velocity at which mechanical excitations travel though the solid. For example, an increase in temperature in the object generally causes a mechanical excitation to travel more slowly in the object. The waveforms due to the two mechanical pulses will thus be offset in time from one another, but otherwise be substantially identical to each other.

At block 125, the first vibrational response is compared to the second vibrational response to determine a change in a temperature in the object. For example, a reference subset of the waveform of the first vibrational response is extracted from the entire waveform. In some embodiments, the reference subset includes about 5 oscillation periods to 20 oscillation periods of the waveform. In some embodiments, a temperature change in the object is determined. For, example, in some embodiments, a temperature change in a specific portion of the object is determined. In some embodiments, a temperature change of a specific portion of the object is determined. In some embodiments, a temperature change of the entire object is determined. In some embodiments, a temperature change in the entire object is determined.

In some embodiments, the reference subset includes oscillation periods after several hundred oscillation periods have already passed.

For example, in some embodiments, the reference subset includes oscillation periods after more than about 100 oscillation periods have already passed or more than about 1000 oscillation periods have already passed. With a number of oscillation periods having passed through the object, this means that the mechanical excitation has travelled through a portion of the object in which a change in the Young's modulus due to a temperature change has occurred numerous times. This increases the offset in time between two mechanical pulses. Thus, allowing more oscillation periods to pass (i.e., waiting a longer time) before creating the reference subset will increase the accuracy of the temperature change determination.

After the second vibrational response is recorded at block 120, a second subset of the waveform of the second vibrational response is extracted from the entire waveform. The second subset includes the same about 5 oscillation periods to 20 oscillation periods of the waveform as the reference subset. The second subset can then compared to the reference subset.

When the temperature of or in the object or a portion of or in the object changes, there will be a difference in the time between the first mechanical pulse and the 5 oscillation periods to 20 oscillation periods of the waveform compared to the time between the second mechanical pulse and the 5 oscillation periods to 20 oscillation periods of the waveform. The time-shift between the reference subset and the second subset is proportional to a change in temperature in the body (i.e., the time shift is proportional to the change in Young's modulus which is in turn proportional to the change in temperature). In some embodiments, the time shift between the reference subset and the second subset is less than about 5 nanosecond (ns) or less than about 1 ns. In some embodiments, a temperature change of about 1° C. or less in an object can be detected with the method 100. If there is no time shift between the reference subset and the second subset, there was no change in temperature in the object.

In some embodiments, the time shift is determined using a using a cross-correlation analysis. In signal processing, cross-correlation is a measure of similarity of two series as a function of the displacement (in time) of one relative to the other.

In some embodiments, a number of first vibrational responses to the first mechanical pulse are record with the object being maintained at a constant temperature. In some embodiments, the waveforms of the first vibrational responses are averaged. A reference subset can be generated with the averaged waveform. In some embodiments, this may increase the accuracy of the determination of the change in temperature in the object.

In some embodiments, a third mechanical pulse is applied to the object and a third mechanical response of the object to the third mechanical response is recorded. Additional mechanical pulses to the object can also be applied. In some embodiments, mechanical pulses are applied to the object at a rate of about 100 Hz or less, 50 Hz or less, or about 15 Hz to 20 Hz. There is no lower limit to the rate at which mechanical pulses can be applied to the object; the rate can be defined by the needed rate of temperature measurement. The upper limit to the rate at which mechanical pulses can be applied to the object is defined by the time period required for the vibrational response to decrease in amplitude below the detectable level. A subset from any of the waveforms of a vibrational response can be compared to one another to determine a temperature change from one point in time to another point in time. That is, a subset of any of the waveforms can serve as the reference subset.

For HTS applications, transducers can be positioned to be in contact with the HTS material to measure the temperature change in the HTS material. Alternatively, transducers can be positioned to be in contact with an object around which HTS material (e.g., wire or tape) is wound. In this case, the temperature change in the HTS material and object can be determined.

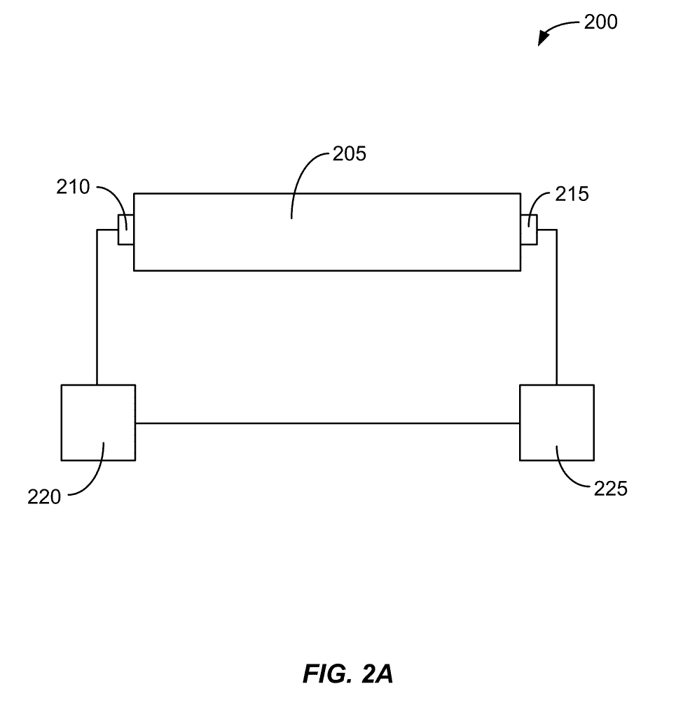

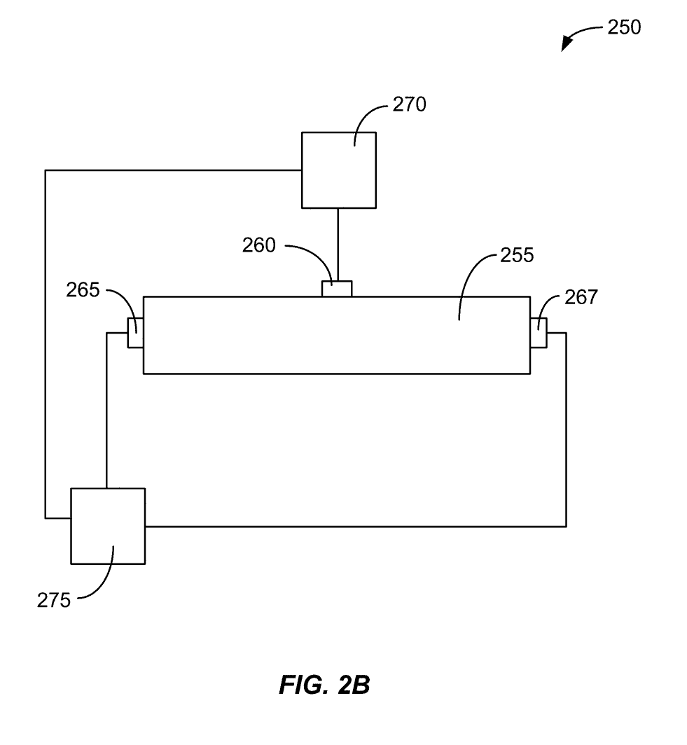

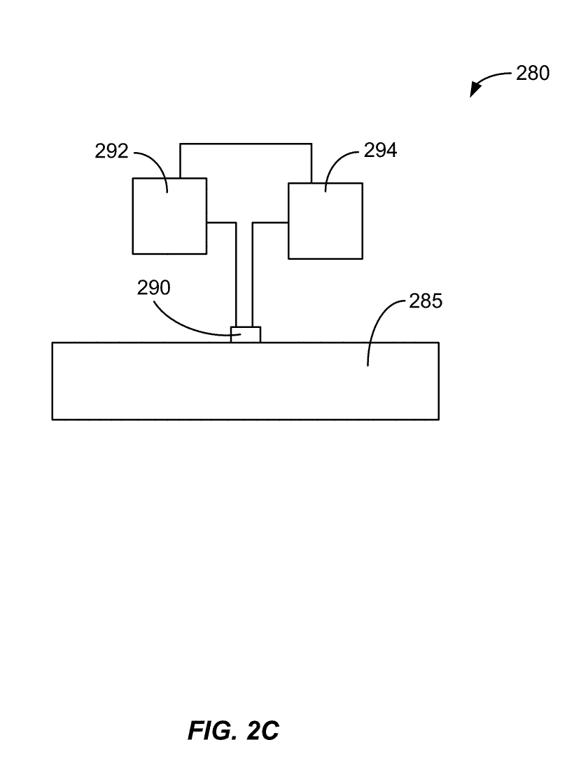

FIGS. 2A-2C show examples of schematic illustrations of apparatus for determining a temperature change in an object. As shown in FIG. 2A, the apparatus 200 includes a transducer 210 operable to generate a mechanical pulse, a transducer 215 operable to detect the vibrational response of an object to a mechanical pulse, a pulse generator 220 operable to send a signal to the transducer 210 to generate a mechanical pulse, and a device 225 operable to record the vibrational response detected by the transducer 215. The transducers 210 and 215 are in contact with an object 205 so that a mechanical pulse can be imparted to the object 205 and the vibrational response of the object 205 can be detected. The pulse generator 220 and the device 225 are in communication with each other so that the device 225 can determine the point in time a mechanical pulse is generated with the transducer 210.

In some embodiments, the transducers 210 and 215 comprise transducers as described above with respect to the method 100, such as piezoelectric transducers. In some embodiments, the device 225 comprises an oscilloscope.

FIG. 2B shows another example of a schematic illustration of an apparatus for determining a temperature change of an object. The apparatus 250 shown in FIG. 2B includes a transducer 260 operable to generate a mechanical pulse, a transducer 265 and a transducer 267 operable to detect the vibrational response of an object to a mechanical pulse, a pulse generator 270 operable to send a signal to the transducer 260 to generate a mechanical pulse, and a device 275 operable to record the vibrational response detected by the transducers 265 and 267. The transducers 260, 265, and 267 are in contact with an object 255 so that a mechanical pulse can be imparted to the object 255 and the vibrational response of the object 255 can be detected. The pulse generator 270 and the device 275 are in communication with each other so that the device 275 can determine the point in time a mechanical pulse is generated with the transducer 260.

In some embodiments, the transducers 260, 265, and 267 comprise transducers as described above with respect to the method 100, such as piezoelectric transducers. In some embodiments, the device 275 comprises an oscilloscope.

The two transducers 265 and 267 are operable to detect a vibrational response of a first portion of the object 255 (i.e., between the transducers 260 and 265) and a vibrational response of a second portion of the object 255 (i.e., between the transducers 260 and 267). Averaging time shifts in the vibrational response of the first portion and the second portion of the object 225 can account for a temperature change in the entire object 225. Subtracting time shifts in the vibrational response of the first portion of the object 225 from the second portion of the object 225 (or vice versa) can account for a temperature difference between the first portion of the object 225 and the second portion of the object 225.

In some embodiments, more transducers (e.g., receiving transducers in addition to the transducers 265 and 267) can be in contact with the body 255. The vibrational responses of the additional receiving transducers to a mechanical pulse can be used to determine the temperature change in a specific portion of the object 255 (e.g., between the receiving transducer and the transducer 260).

FIG. 2C shows another example of a schematic illustration of an apparatus for determining a temperature change of an object. The apparatus 280 shown in FIG. 2C includes a transducer 290 operable to generate a mechanical pulse and operable to detect the vibrational response of an object to the mechanical pulse, a pulse generator 292 operable to send a signal to the transducer 290 to generate a mechanical pulse, and a device 294 operable to record the vibrational response detected by the transducer 290. The transducer 290 is in contact with an object 285 so that a mechanical pulse can be imparted to the object 285 and the vibrational response of the object 285 can be detected. The pulse generator 292 and the device 294 are in communication with each other so that the device 294 can determine the point in time a mechanical pulse is generated with the transducer 290.

In some embodiments, the transducer 290 comprises a transducer as described above with respect to the method 100, such as a piezoelectric transducer. In some embodiments, the device 294 comprises an oscilloscope.

Using a single transducer to both generate a mechanical pulse and detect the vibrational response of an object to the mechanical pulse would allow for the detection of a temperature change proximate the transducer or in the vicinity of the transducer. Moreover, by monitoring the vibrational response waveform further (in time) from the original pulse, location-dependent temperature monitoring can be accomplished.

Embodiments of the methods described herein also can achieve spatial selectivity when applied to multi-part bodies. For example, having solved a vibrational model of the object (e.g., by finite-element analysis or analytically), vibrational mode frequencies corresponding to its specific subparts can potentially be identified. If the object response waveforms are then band-pass filtered around one such frequency and processed as described above, temperature of that corresponding subpart can be monitored independently of the rest of the object.

The following examples are intended to be examples of the embodiments disclosed herein, and are not intended to be limiting.

### Example—Finite-Element Transient Simulation

A finite-element transient simulation for a model system that resembles a section of a flat coil wound with a tape conductor was conducted. The model system consisted of eleven 100 μm-thick stainless tapes inter-separated by ten 25 μm thick polyethylene tapes stacked together. The tape stack was sandwiched between two 1 mm thick copper plates. The assembly length was 120 mm, and its width was 12 mm. Solid (i.e., frozen) contacts between all constituent parts were considered. Two round piezoelectric transducers were placed at the outer surfaces of the top and bottom copper plates, respectively. The transducers were modelled as 0.1 mm-thick disks, 6 mm in diameter placed along the middle line of the tapes at a 25 mm distance from the ends of the stack. They were assumed to have an isotropic Young's modulus of 9.6×10¹⁰ Pa, Poisson ratio of 0.36, polarization constant d₃₃=15.1 C/m², and the polarization direction aligned with the transverse axis of the stack.

The transmitting transducer was energized with a 0.2 μs long rectangular 10 V pulse and the transient displacement as well as the voltage across the receiving transducer was calculated for the interval of 600 μs using a constant time step of 0.2 μs. Two simulations were performed: one for an unmodified stack using reference material parameters (at a base temperature of 295 K), and another one for a modified stack where the Young's modulus E of the middle (6th) stainless tape was decreased along its entire length by 1% relative to the initial value of 1.93×10¹¹ Pa in order to emulate the effect of a temperature rise.

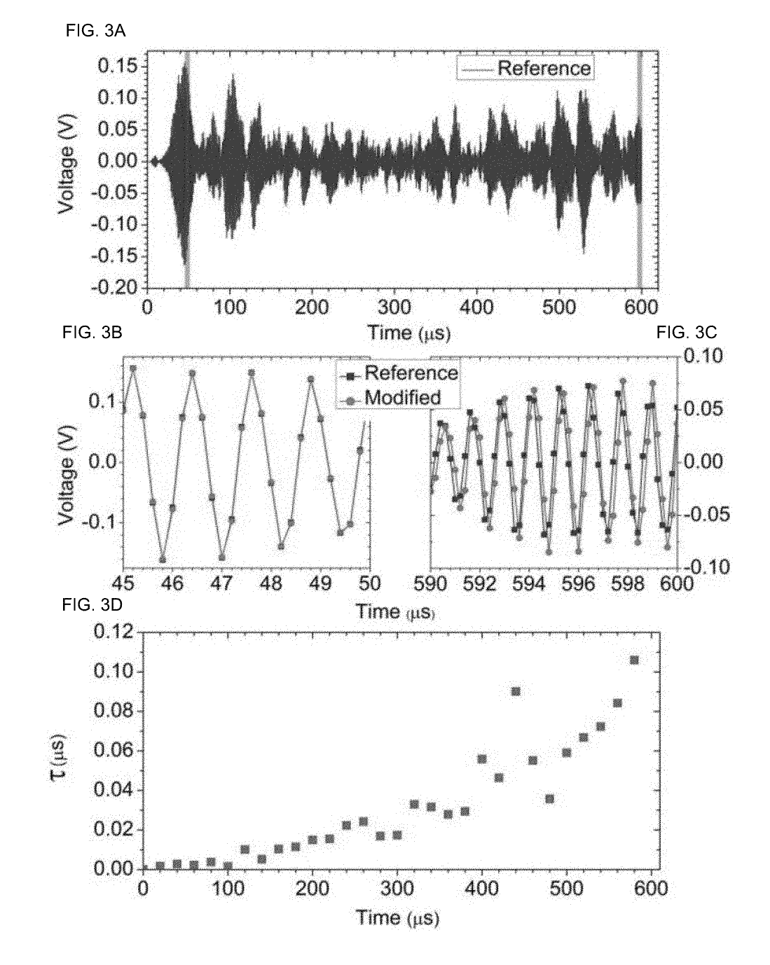

The results of the transient displacement calculation show that as the initial excitation propagates away from the transmitter, various volumetric and lateral eigenmodes are excited, eventually leading to a formation of a complex time-varying displacement pattern across the stack volume. The voltage across the receiver transducer for the unmodified stack is plotted in FIG. 3A. The transducer was assumed to be grounded at the side bonded to the copper plate, and the plotted voltage is the average (Vnin+Vmax)/2 taken across its outer surface at each step of the calculation. The transient exhibits a prevailing frequency centered at ˜860 kHz, and a complex envelope pattern resulting from interference of multiple wave modes. The same transient waveform was calculated for the modified stack, and then two sub-waveforms were selected from each transient. They were compared directly and also using the cross-correlation method (2).

For the two sub-waveforms selected at t=45 μs, their relative time shift appears to be negligible. However, for the two selected further into the transient (at t=595 μs), a measurable relative time shift is seen, corresponding to an increase in the oscillation period for the modified stack. In FIG. 3D, the relative time shift τ(t) calculated using (2) for the corresponding sub-waveform blocks of t_{w}=20 μs of the reference and modified transient is plotted. The origin of the observed roughly quadratic character of τ(t) requires further investigation by varying structural parameters of the system, and possibly modifying the simulation time step. The assumed ΔE/E=0.01 for stainless steel corresponds to a temperature rise of ˜25 K, which would constitute a rather large thermal detection threshold for a real HTS conductor stack. This variation magnitude was simply chosen to reduce the simulation time. However, as the result of FIG. 3D shows, τ(τ) accumulated over ˜600 μs of the transient corresponds to a substantial phase shift of 31° at 860 kHz, suggesting a potentially large temperature sensitivity margin. It should be noted that the transient time shift is expected to be additive over any thermally perturbed volume; it is therefore expected that this simulation will provide a correct order of magnitude estimate also in the case of a localized “hot spot.”

### Example—Experimental Tests

To validate the technique as a quench detection tool, it was tested experimentally using a stacked tape assembly built around a practical HTS tape conductor. The conductor had an ˜1 μm-thick yttrium barium copper oxide (YBCO) layer deposited on buffer layers on top of the 12 mm wide Hastelloy substrate, and stabilized by a surrounded silver and copper stabilizer of 40 μm overall thickness. The net thickness of the HTS tape was ˜100 μm. To define the artificial “hot spot,” two notches were made in the stabilizer and YBCO layers, thus forming a locally reduced path for the current. The conductor was then stacked with five 12 mm wide and 100 μm thick stainless tapes at each side, having an adhesive 25 μm thick Kapton foil placed in-between the adjacent tapes. The entire stack was bonded layer-by-layer using cyanoacrylate glue, placed and bonded inside a rectangular shaped copper channel, and a 1 mm thick copper plate was added at the top. Two piezo-transducers made of 100 μm thick transversely polarized lead-strontium-titanate film deposited on 150 μm thick bronze disks of 1 cm in diameter were glued at the opposite sides of the assembly, at 5 cm from its ends. The HTS conductor was spliced to the current leads using six 0.1 mm-thick copper tapes at each end, three tapes at each conductor side. Voltage taps were soldered at the YBCO side ˜1 cm from the conductor ends.

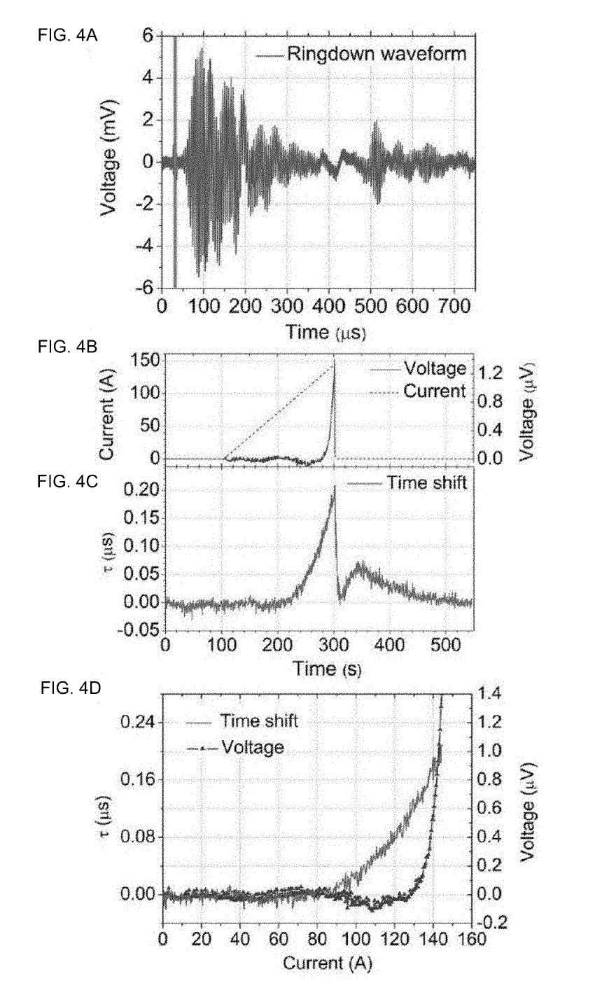

The tests were conducted in a liquid nitrogen bath. Rectangular voltage pulses of 14 V amplitude were applied to the transmitter transducer at a rate of 9 Hz using a function generator. The excitation pulse duration was set to 7.2μs, which yielded the largest amplitude and longest observed ringing down of the transient waveform. The latter was recorded directly from the receiver transducer by an oscilloscope at a 40 MHz sampling rate (FIG. 4A). The prevailing frequency component of the transient was ˜200 kHz. Next, a reference sub-waveform of 75 μs duration was selected starting at ˜220 μs from the leading edge of the excitation pulse. It was re-acquired and averaged 10 times; the resulting waveform was stored and then continuously monitored for time shift τ(τ) using the algorithm (2) implemented with software. Initially, τ(t) was monitored for ˜100 s at zero driving current, and it did not show a notable change fluctuating in the ±0.03 μs range. Boiling nitrogen in the cryostat did not seem to affect the signal. Next, current was applied to the tape conductor in a linear ramp fashion at a rate of 1.37 A/s, and the voltage between the taps was measured using a nanovoltmeter.

Results of the simultaneous τ and voltage measurement as function of time are shown in FIG. 4B and FIG. 4C, while the same results as function of the driving current are shown in FIG. 4D. As the current increases, the resistive voltage across the conductor becomes detectable at ˜120 A and reaches 1 μ/V at 143 A. At the same time, τ(τ) starts to increase monotonically with current at around 80 A, reaching ˜0.2 μs peak value at the maximum current of 143 A. Once the current is switched off, τ(τ) jumps down quickly, partly recovers, and then follows a transitional decay for ˜140 s towards its initial level prior to the current ramp. The slow decay may be related to a cooling of the stack interior, and spatial re-distribution of the deposited heat. The entire experiment was then repeated, yielding the same magnitude of the time shift, and a fully reproducible current-voltage characteristic of the conductor. When compared to the prevalent period of the transient, the measured peak of τ(t) during the resistive transition in the HTS conductor corresponds to 14° of net phase shift with respect to the reference sub-waveform. Given that ˜45 transient oscillation have taken place in the 220 μs prior to the accumulated sub-waveform, this translates into ˜8×10⁻⁴ of the relative frequency shift for the most prominent (200 kHz) vibrational eigenmode of the stack assembly. Notably, the τ(t) rise precedes the voltage rise, and in fact coincides with an onset of a small −0.1 μV voltage across the tape appearing at ˜90 A. Such a “reversed” voltage anomaly in a current-voltage characteristic of HTS tape is often associated with the resistive transition that occurs outside of the segment between the voltage taps, but diverts some current into the stabilizer layer of that segment due to a finite current diffusion length.

The net heat release in the conductor estimated as power integrated over the duration of the ramp is ˜1.27 mJ. By using temperature-dependent values for the heat capacities of the conductor materials, and assuming the normal zone length along the tape of 1 mm, this heat amount yields a local temperature rise of ˜0.6 K (or a proportionally smaller number for a larger-sized normal zone) in adiabatic approximation. Based on (1) and the reference Young's modulus values for the conductor materials, the relative eigenfrequency change corresponding to such temperature variation is expected to be ˜5×10⁻⁵. One can speculate that the substantially larger frequency shift observed in our experiment can be attributed to the Young's modulus changes of the insulation layers (e.g., glue) surrounding the conductor, or amplified by thermally induced interfacial contact changes in the stack.

In conclusion, an active technique for detecting quenches in HTS conductor stack assemblies based on monitoring their transient acoustic response was described above. The capability to resolve a temperature rise of less than 1 K in the conductor quenching inside a stack at 77 K, while the resistive voltage across that conductor was still less than 1 μV, has been demonstrated. This technique has a potential for detecting hot spots in larger conductor assemblies, coils, and machinery where such capability is crucial for adequate quench protection. While increasing system size may decrease an acoustic wave fraction affected by the thermally perturbed volume, preliminary tests indicate that sensitivity of the technique should be sufficient for detecting quenches in HTS tape windings of at least ˜100 m in length. A signal-to-noise ratio can be lowered by increasing acoustic wave energy proportionally to system size. The technique can be potentially made spatially selective by band-pass filtering the transient around eigenfrequencies of a specific structural part of the system and may benefit from exploiting acoustic transmission windows of cable stacks and coil windings. In combination with passive acoustic localization, quench location information can be obtained simultaneously with quench detection, using the same sensor hardware. Also, a large scope of applications may exist in areas beyond superconductor-based devices where fast, non-invasive detection of local temperature changes in the interior of a solid object is required.

### CONCLUSION

Further details regarding the embodiments described herein can be found in M. Marchevsky and S. A. Gourlay, “Acoustic thermometry for detecting quenches in superconducting coils and conductor stacks,” Appl. Phys. Lett. 110, 012601 (2017), which is herein incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
(a) applying a first mechanical pulse to an object;
(b) recording a first vibrational response of the object to the first mechanical pulse;
(c) applying a second mechanical pulse to the object;
(d) recording a second vibrational response of the object to the second mechanical pulse; and
(e) comparing the second vibrational response to the first vibrational response to determine a change in a temperature in the object.

2. The method of claim 1, wherein the object is a solid object.

3. The method of claim 1, wherein the first mechanical pulse and the second mechanical pulse have a same amplitude and a same duration.

4. The method of claim 1, wherein operations (a) and (c) are performed with a piezoelectric transducer.

5. The method of claim 1, wherein operations (a) and (c) are performed with a transducer selected from a group consisting of a piezoelectric transducer, an electromagnetic acoustic transducer, and a pulsed laser beam.

6. The method of claim 1, wherein operations (b) and (d) are performed with a piezoelectric transducer.

7. The method of claim 1, wherein operations (b) and (d) are performed with transducer selected from a group consisting of a piezoelectric transducer, an electromagnetic acoustic transducer, and a laser.

8. The method of claim 1, wherein operations (b) and (d) are performed using an oscilloscope.

9. The method of claim 1, wherein the first mechanical pulse and the second mechanical pulse each have a duration of about 0.1 microseconds to 50 microseconds.

10. The method of claim 1, wherein the first mechanical pulse and the second mechanical pulse are each rectangular mechanical pulses.

11. The method of claim 1, wherein the second mechanical pulse is applied about 2 milliseconds to 5 milliseconds after the first mechanical pulse is applied to the object.

12. The method of claim 1, wherein the first mechanical pulse and the second mechanical pulse each have an energy of less than about 1 millijoule.

13. The method of claim 1, wherein the change in the temperature in the object is less than about 1° C.

14. The method of claim 1, wherein operation (e) includes determining a time difference in the first vibrational response and the second vibrational response.

15. The method of claim 14, wherein time difference is proportional to the change in the temperature change.

16. The method of claim 14, wherein the time difference is less than about 1 nanosecond.

17. The method of claim 1, further comprising:
(f) applying a third mechanical pulse to the object;
(g) recording a third vibrational response of the object to the third mechanical pulse; and
(h) comparing the first vibrational response to the third vibrational response to determine a second change in the temperature in the object.

18. The method of claim 17, wherein the first mechanical pulse, the second mechanical pulse, and the third mechanical pulse are applied at a rate of about 100 Hz or less.

19. The method of claim 1, wherein operation (e) includes:
extracting about 5 oscillation periods to 20 oscillations periods of a first waveform of the first vibrational response of the object;
determining a first time, wherein the first time is a period of time between the application of the first mechanical pulse to the object and the about 5 oscillation periods to 20 oscillations periods of the first waveform;
extracting about 5 oscillation periods to 20 oscillations periods of a second waveform of the second vibrational response of the object;
determining a second time, wherein the second time is a period of time between the application of the second mechanical pulse to the object and the about 5 oscillation periods to 20 oscillations periods of the second waveform; and
determining a time difference between the first time and the second time, wherein the time difference is proportional to a change in the temperature in the object.

20. The method of claim 19, wherein the time difference is determined using a cross-correlation analysis.
